(19) United States
(12) Patent Application Publication
(10) Pub. No.: US 2023/0054442 A1
(43) Pub. Date: Feb. 23, 2023

(54) SILICON-CONTAINING NEGATIVE ELECTRODE ACTIVE MATERIAL, NEGATIVE ELECTRODE INCLUDING SAME, AND SECONDARY BATTERY INCLUDING SAME

(71) Applicant: LG Energy Solution, LTD., Seoul (KR)

(72) Inventors: Junghyun CHOI, Daejeon (KR); Su Min LEE, Daejeon (KR); Sun Young SHIN, Daejeon (KR); Yong Ju LEE, Daejeon (KR)

(73) Assignee: LG Energy Solution, LTD., Seoul (KR)

(21) Appl. No.: 17/885,722

(22) Filed: Aug. 11, 2022

(30) Foreign Application Priority Data
Aug. 13, 2021 (KR) 10-2021-0107512
Jan. 20, 2022 (KR) 10-2022-0008544

(51) Int. Cl. H01M 4/36; H01M 4/583; H01M 4/48; H01M 4/133; H01M 4/131

(52) U.S. Cl. CPC H01M 4/366; H01M 4/583; H01M 4/48; H01M 4/133; H01M 4/131; H01M 2004/027

(57) ABSTRACT

A silicon-containing negative electrode active material including a core and a carbon layer disposed on the core, in which the core includes SiOₓ, wherein 0<x<2 and at least one metal atom, the at least one metal atom includes at least one selected from the group consisting of Mg, Li, Al and Ca, D₅/D₅₀ is 0.5 or more, D₅ is 3 μm or more, and D₅₀ is 4 μm or more and 11 μm or less, a negative electrode including the same, and a secondary battery including the same.

### CROSS-REFERENCE TO RELATED APPLICATIONS

This application claims priority to and the benefit of Korean Patent Application No. 10-2021-0107512 filed in the Korean Intellectual Property Office on Aug. 13, 2021 and Korean Patent Application No. 10-2022-0008544 filed in the Korean Intellectual Property Office on Jan. 20, 2022, the entire contents of which are incorporated herein by reference.

### TECHNICAL FIELD

The present invention relates to a silicon-containing negative electrode active material having a specific particle size distribution, a negative electrode including the same and a secondary battery including the same.

### BACKGROUND ART

Demands for the use of alternative energy or clean energy are increasing due to the rapid increase in the use of fossil fuels, and as a part of this trend, the most actively studied field is a field of electricity generation and electricity storage using an electrochemical reaction.

Currently, representative examples of an electrochemical device using such electrochemical energy include a secondary battery, and the usage areas thereof are increasing. Recently, as the technological development and demand for portable devices such as portable computers, portable phones, and cameras have increased, the demand for secondary batteries as an energy source has increased sharply, and numerous studies have been conducted on a lithium secondary battery having a high energy density, that is, a high capacity among such secondary batteries, and the lithium secondary battery having a high capacity has been commercialized and widely used.

In general, a secondary battery includes a positive electrode, a negative electrode, an electrolyte, and a separator. The negative electrode includes a negative electrode active material for intercalating and de-intercalating lithium ions from the positive electrode, and as the negative electrode active material, a silicon-containing active material having high discharge capacity may be used.

However, a silicon-containing active material is accompanied by an excessive volume change in a process of driving a battery. Accordingly, there occurs a problem in that the service life of the battery is reduced. To solve these problems in the related art, methods of reducing the ratio of silicon-containing active material used or using a binder capable of showing a high negative electrode adhesion are used, but there is a limitation in solving the problem because the silicon-containing active material itself is not improved. Further, although a technique capable of internally accommodating volume expansion by making a silicon-containing active material porous has been used, the technique has a problem in that the effect is reduced because a capacity per weight of a negative electrode is reduced and particles are destroyed when the electrode is prepared, and then roll pressed.

Therefore, there is an urgent need for the development of a silicon-containing negative electrode active material capable of effectively improving the service life characteristics of a battery.

### RELATED ART DOCUMENT

### Patent Document

(Patent Document 1) Korean Patent No. 10-1586816

### SUMMARY OF THE INVENTION

The present invention has been made in an effort to provide a silicon-containing negative electrode active material capable of improving the capacity, efficiency and/or service life characteristics of a battery, a negative electrode including the same and a secondary battery including the same.

An exemplary embodiment of the present invention provides a silicon-containing negative electrode active material including a core and a carbon layer on the core, in which the core includes SiOₓ (0<x<2) and at least one metal atom, the at least one metal atom includes at least one selected from the group consisting of Mg, Li, Al and Ca, D₅/D₅₀ is 0.5 or more, D₅ is 3 μm or more, and D₅₀ is 4 μm or more and 11 μm or less.

Another exemplary embodiment of the present invention provides a negative electrode including a negative electrode active material, in which the negative electrode active material includes the silicon-containing negative electrode active material.

Still another exemplary embodiment of the present invention provides a secondary battery including the negative electrode.

The silicon-containing negative electrode active material according to an exemplary embodiment of the present invention has a D₅/D₅₀ of 0.5 or more, a D₅ of 3 μm or more, and a D₅₀ of 4 μm or more and 11 μm or less, so that the capacity, efficiency and/or service life characteristics of a battery can be improved because lithium ions are readily intercalated and de-intercalated during charging and discharging while causing no excessive side reaction with an electrolytic solution, and an excessive swelling is not caused. Further, since the silicon-containing negative electrode active material includes at least one metal atom and the at least one metal atom is present in the form of a metal compound such as a metal silicate, the initial efficiency of the battery can be improved.

### DETAILED DESCRIPTION

Hereinafter, the present invention will be described in more detail in order to help the understanding of the present invention.

The terms or words used in the present specification and the claims should not be construed as being limited to typical or dictionary meanings, and should be construed as meanings and concepts conforming to the technical spirit of the present invention on the basis of the principle that an inventor can appropriately define concepts of the terms in order to describe his or her own invention in the best way.

The terms used in the present specification are used only to describe exemplary embodiments, and are not intended to limit the present invention. Singular expressions include plural expressions unless the context clearly indicates otherwise.

In the present invention, the term “comprise”, “include”, or “have” is intended to indicate the presence of the characteristic, number, step, constituent element, or any combination thereof implemented, and should be understood to mean that the presence or addition possibility of one or more other characteristics or numbers, steps, constituent elements, or any combination thereof is not precluded.

In the present specification, D₅ and D₅₀ may be defined as a particle size corresponding to 5% and 50%, respectively, of the volume cumulative amount in a particle size distribution curve (graph curve of the particle size distribution map) of the particles. Furthermore, in the present specification, Dₘₐₓ and Dₘᵢₙ may correspond to the largest particle size and the smallest particle size in the particle size distribution curve of particles, respectively. The D₅, D₅₀, Dₘₐₓ and Dₘᵢₙ may be measured using, for example, a laser diffraction method, respectively. The laser diffraction method can generally measure a particle size of about several mm from the submicron region, and results with high reproducibility and high resolution may be obtained. The measurement of the D₅ and D₅₀ may be confirmed using water and Triton-X100 dispersant under conditions of a refractive index of 1.97 using a Microtrac apparatus (manufacturer: Microtrac model name: S3500).

In the present specification, a BET specific surface area may be measured by degassing gas from an object to be measured at 130° C. for 2 hours using a BET measuring apparatus (BEL-SORP-MAX, Nippon Bell), and performing N₂ adsorption/desorption at 77 K.

In the present specification, the presence or absence of a metal element and the content of the element in a negative electrode active material can be confirmed by ICP analysis, and the ICP analysis may be performed using an inductively coupled plasma atomic emission spectrometer (ICP-OES AVIO 500 of Perkin-Elmer 7300).

<Silicon-Containing Negative Electrode Active Material>

An exemplary embodiment of the present invention provides a silicon-containing negative electrode active material layer including a core and a carbon layer disposed on the core, in which the core includes SiOₓ (0<x<2) and at least one metal atom, the at least one metal atom includes at least one selected from the group consisting of Mg, Li, Al and Ca, D₅/D₅₀ is 0.5 or more, D₅ is 3 μm or more, and D₅₀ is 4 μm or more and 11 μm or less.

In an exemplary embodiment of the present invention, the silicon-containing negative electrode active material includes a core.

In an exemplary embodiment of the present invention, the core includes SiOₓ (0<x<2).

The SiOₓ (0<x<2) may correspond to a matrix in the silicon-containing negative electrode active material. The SiOₓ (0<x<2) may be in a form including Si and SiO₂, and the Si may also form a phase. That is, the x corresponds to the number ratio of 0 for Si included in the SiOₓ (0<x<2). When the silicon-containing negative electrode active material includes SiOₓ (0<x<2), the discharge capacity of a secondary battery may be improved.

In an exemplary embodiment of the present invention, the core may include a metal atom. The at least one metal atom may be present in the form of at least one of a metal atom, a metal silicate, a metal silicide, and a metal oxide in the silicon-containing negative electrode active material.

The at least one metal atom may include at least one selected from the group consisting of Mg, Li, Al and Ca. Accordingly, the initial efficiency of the silicon-containing negative electrode active material may be improved.

Specifically, the metal atom may include one or more of Mg, Li or Al. The silicon-containing negative electrode active material of the present invention may be in a form in which particles having a relatively small size are removed, but, when the metal atom is one or more of Mg, Li or Al, a silicon-containing negative electrode active material having the above-mentioned characteristics may be smoothly prepared because even the inside of the core may be uniformly doped. Further, in the silicon-containing negative electrode active material having a particle size distribution of the present invention, a metal atom having a low atomic number is small, so that the metal atom is most preferably Mg or Li because the inside of the core may be more uniformly doped.

The metal atom (Li, Mg, and the like) is in a form in which the silicon-containing particles are doped with the atom, and thus may be distributed on the surface and/or inside of the silicon-containing particle. The metal atoms are distributed on the surface and/or inside of the silicon-containing particle, and thus may control the volume expansion/contraction of the silicon-containing particles to an appropriate level, and may serve to prevent damage to the active material. Further, the metal atom may be contained from the aspect of reducing the ratio of the irreversible phase (for example, SiO₂) in the SiOₓ (0<x<2) particles to increase the efficiency of the active material.

The metal atom may be present in the form of a metal silicate. The metal silicate may be classified into a crystalline metal silicate and an amorphous metal silicate.

When the metal atom is Li, Li may be present in the form of at least one lithium silicate selected from the group consisting of Li₂SiO₃, Li₄SiO₄ and Li₂Si₂O₅ in the core.

When the metal atom is Mg, Mg may be present in the form of at least one magnesium silicate of Mg₂SiO₄ and MgSiO₃ in the core.

In an exemplary embodiment of the present invention, the metal atom may be included in an amount of 0.1 part by weight or more and 40 parts by weight or less, specifically 1 part by weight or more and 25 parts by weight or less, and more specifically 2 parts by weight or more and 20 parts by weight or less or 2 parts by weight or more and 10 parts by weight or less, based on a total 100 parts by weight of the silicon-containing negative electrode active material. When the content of the metal atom exceeds the above range of 0.1 part by weight or more and 40 parts by weight or less, there may be a problem in that as the content of the metal atoms is increased, the initial efficiency is increased, but the discharge capacity is decreased, so that when the content satisfies the above range, appropriate discharge capacity and initial efficiency may be implemented.

In an exemplary embodiment of the present invention, the metal atom may be included in an amount of 1 part by weight or more and 25 parts by weight or less, more specifically 2 parts by weight or more and 20 parts by weight or less or 2 parts by weight or more and 10 parts by weight or less, based on a total 100 parts by weight of the core. When the content of the metal atom exceeds the above range of 1 part by weight or more and 25 parts by weight or less, there may be a problem in that as the content of the metal atoms is increased, the initial efficiency is increased, but the discharge capacity is decreased, so that when the content satisfies the above range, appropriate discharge capacity and initial efficiency may be implemented.

In an exemplary embodiment of the present invention, the silicon-containing negative electrode active material may include a carbon layer. The carbon layer is disposed on the core, and may cover at least a part of the surface of the core. That is, the carbon layer may be in the form of partially covering the surface of the core, or covering the entire core surface. By the carbon layer, conductivity may be imparted to the silicon-containing negative electrode active material, and the initial efficiency, service life characteristics, and battery capacity characteristics of the secondary battery may be improved.

The carbon layer may include at least one of amorphous carbon and crystalline carbon.

The crystalline carbon may further improve the conductivity of the silicon-containing negative electrode active material. The crystalline carbon may include at least one selected in the group consisting of fullerene, carbon nanotubes and graphene.

The amorphous carbon may suppress the expansion of the silicon-containing composite particles by appropriately maintaining the strength of the carbon layer. The amorphous carbon may be a carbon-containing material formed using at least one carbide selected from the group consisting of tar, pitch and other organic materials, or a hydrocarbon as a source of a chemical vapor deposition method.

The carbide of the other organic materials may be a carbide of sucrose, glucose, galactose, fructose, lactose, mannose, ribose, aldohexose or ketohexose and a carbide of an organic material selected from combinations thereof.

The hydrocarbon may be a substituted or unsubstituted aliphatic or alicyclic hydrocarbon, or a substituted or unsubstituted aromatic hydrocarbon. The aliphatic or alicyclic hydrocarbon of the substituted or unsubstituted aliphatic or alicyclic hydrocarbon may be methane, ethane, ethylene, acetylene, propane, butane, butene, pentane, isobutane, hexane, or the like. Examples of the aromatic hydrocarbon of the substituted or unsubstituted aromatic hydrocarbon include benzene, toluene, xylene, styrene, ethylbenzene, diphenylmethane, naphthalene, phenol, cresol, nitrobenzene, chlorobenzene, indene, coumarone, pyridine, anthracene, phenanthrene, or the like.

In an exemplary embodiment of the present invention, the carbon layer may be included in an amount of 0.1 part by weight or more and 50 parts by weight or less, 0.1 part by weight or more and 30 parts by weight or less or 0.1 part by weight or more and 20 parts by weight or less, based on a total 100 parts by weight of the silicon-containing negative electrode active material. More specifically, the carbon layer may be included in an amount of 0.5 part by weight or more and 15 parts by weight or less. When the above range of 0.1 part by weight or more and 50 parts by weight or less is satisfied, it may be possible to prevent a decrease in the capacity and efficiency of the negative electrode active material.

In an exemplary embodiment of the present invention, the carbon layer may have a thickness of 1 nm to 500 nm, specifically 5 nm to 300 nm. When the above range of 1 nm to 500 nm is satisfied, the conductivity of the silicon-containing negative electrode active material may be improved, so that there is an effect that the initial efficiency and service life of the battery are improved.

In an exemplary embodiment of the present invention, the silicon-containing negative electrode active material may have a D₅₀ of 4 μm or more and 11 μm or less. When the silicon-containing negative electrode active material has a D₅₀ less than 4 μm, the particle size may be so small that the specific surface area of the material is increased, so that there may be a problem in that the service life severely deteriorates because many side reactions with an electrolytic solution occur. When the silicon-containing negative electrode active material has a D₅₀ more than 11 μm, the particle size may be so large that the battery may not readily charged and discharged, so that there may be a problem in that it is difficult to implement the capacity/efficiency during charging and discharging. Therefore, when the silicon-containing negative electrode active material has a D₅₀ of 4 μm or more and 11 μm or less, the battery may be readily charged and discharged, so that there may be an effect that the capacity and efficiency are properly implemented and service life characteristics are stable. In particular, the silicon-containing negative electrode active material may have a D₅₀ of 4.2 μm or more and 10 μm or less, specifically 4.5 μm or more and 9 μm or less, and more specifically 5 μm or more and 7 μm or less. In this case, in addition to the above-described effect, there may be an effect that the electrode can be easily prepared.

In an exemplary embodiment of the present invention, the silicon-containing negative electrode active material may have a D₅ of 3 μm or more. When the silicon-containing negative electrode active material a D₅ of less than 3 μm, oxidation may occur frequently due to the small particle size, so that there may be a problem in that the capacity and efficiency are implemented as being relatively small. Further, since side reactions with an electrolytic solution may be increased during charging/discharging due to the small particle size, there may be a problem in that the service life characteristics deteriorate. Therefore, when the above range of 3 μm or more is satisfied, the content of the silicon-containing negative electrode active material having an excessively small particle size in the negative electrode may be decreased, so that the service life and stability of the battery may be improved by reducing side reactions with an electrolytic solution. In particular, the silicon-containing negative electrode active material may have a D₅ of 3 μm or more and 5.5 μm or less, specifically 3 μm or more and 5 μm or less, and more specifically 3 μm or more and 4 μm or less or 3 μm or more and 3.6 μm or less.

The silicon-containing negative electrode active material may have a D₅/D₅₀ of 0.5 or more, specifically 0.6 or more. When the D₅/D₅₀ is less than 0.5, the volume occupied by the silicon-containing negative electrode active material having an excessively small size in the negative electrode may increase, so that there may be a problem in that the service life of the battery is reduced because side reactions with an electrolytic solution may be increased as the specific surface area of the material may be increased. Therefore, the D₅/D₅₀ satisfies 0.5 or more, so that the service life characteristics of the battery may be improved. The upper limit of the D₅/D₅₀ of the silicon-containing negative electrode active material may be 1.

In this case, when the D₅/D₅₀ is less than 0.5 even though the D₅ and D₅₀ of the silicon-containing negative electrode active material satisfy the above ranges, side reactions with an electrolytic solution may be increased because the volume occupied by an active material having an even smaller size than D₅₀ in the negative electrode may be increased, so that the service life of the battery may be reduced. In contrast, when the D₅/D₅₀ satisfies 0.5 or more, but the D₅ or D₅₀ do not satisfy the above ranges, the average particle size may be so small or large, that there occurs a problem in that it is difficult to implement the service life and/or efficiency. When the D₅ or D₅₀ is small, there is a problem in that the capacity and efficiency are lowered because a large amount of the silicon-containing negative electrode active material particles are oxidized, and the service life characteristics deteriorate due to an excessive electrolytic solution side reaction. When the D₅₀ is high, the particle size is so large that the battery is not readily charged and discharged, so that there is a problem in that it is difficult to implement the capacity/efficiency during charging and discharging.

Therefore, as in the present invention, when the D₅, D₅₀ and D₅/D₅₀ of the silicon-containing negative electrode active material satisfy the above ranges, the capacity, efficiency and/or service life and/or efficiency of the battery may be improved.

In an exemplary embodiment of the present invention, the silicon-containing negative electrode active material may have a BET specific surface area of 1 m²/g or more and 20 m²/g or less, 1 m²/g or more and 15 m²/g or less, more than 2 m²/g and less than 10 m²/g, and 2.5 m²/g or more and 8 m²/g or less.

The upper limit of the BET specific surface area may be 20 m²/g, 18 m²/g, 15 m²/g, 10 m²/g, 8 m²/g, 5 m²/g or 4 m²/g, and the lower limit thereof may be 1 m²/g, 1.5 m²/g, 2 m²/g or 2.5 m²/g.

In an exemplary embodiment of the present invention, the silicon-containing negative electrode active material may have a Dₘₐₓ of 35 μm or less, specifically 30 μm or less, and more specifically 25 μm or less or 20 μm or less. When the above range of 35 μm or less is not satisfied, there is a problem in that due to the excessively large particles, the electrode may be not easily prepared, and the electrode may be non-uniformly prepared during roll pressing.

The silicon-containing negative electrode active material may have a Dₘᵢₙ of 1.3 μm or more, specifically 1.5 μm or more, and more specifically 1.7 μm or more or 2 μm or more. When the above range of 1.3 μm or more is satisfied, the specific surface area of the material may not become too large, so that there may be an effect capable of reducing side reactions with an electrolytic solution.

In an exemplary embodiment of the present invention, the silicon-containing negative electrode active material may be formed through preparing a preliminary silicon-containing negative electrode active material; adjusting the particle size of the preliminary silicon-containing negative electrode active material; and forming a carbon layer on the preliminary silicon-containing negative electrode active material whose particle size is controlled.

Specifically, in the preparing of the preliminary silicon-containing negative electrode active material, the preliminary silicon-containing negative electrode active material may be formed through mixing a Si powder, a SiO₂ powder and a metal powder, and then vaporizing the mixture; condensing the vaporized mixed gas into a solid phase; and heat-treating the solid phase in an inert atmosphere.

Alternatively, the preliminary silicon-containing negative electrode active material may be formed through forming silicon-containing particles by heating and vaporizing a Si powder and a SiO₂ powder under vacuum, and then depositing the vaporized mixed gas; and mixing the formed silicon-containing particles and a metal powder, and then heat-treating the resulting mixture.

The heat-treating step may be performed at 700° C. to 900° C. for 4 hours to 6 hours, specifically at 800° C. for 5 hours.

The metal powder may be a Mg powder or a Li powder.

When a Mg powder is used as the metal powder, a negative electrode active material may be prepared by vaporizing the Mg powder.

When a Li powder is used as the metal powder, a negative electrode active material may be prepared by mixing silicon-containing particles and the Li powder, and then heat-treating the resulting mixture.

The silicon-containing particles may be SiOx (x=1).

In the preliminary silicon-containing negative electrode active material, the Mg compound phase may include the above-described Mg silicates, Mg silicides, Mg oxides, and the like.

In the preliminary silicon-containing negative electrode active material, the Li compound phase may include the above-described Li silicates, Li silicides, Li oxides, and the like.

In the adjusting of the particle size of the preliminary silicon-containing negative electrode active material, the particle size may be adjusted by a method such as a ball mill, a jet mill, or an air current classification, and the method is not limited thereto. For example, when the particle size of the preliminary silicon-containing negative electrode active material is adjusted using a ball mill, 5 to 20 sus ball media may be added, and specifically 10 to 15 sus ball media may be added, but the number of sus ball media is not limited thereto.

In the adjusting of the particle size, the grinding time of the preliminary silicon-containing negative electrode active material may be 2 hours to 5 hours, specifically 2 hours to 4 hours, and more specifically 3 hours, but is not limited thereto.

In the forming of the carbon layer, the carbon layer may be prepared by using a chemical vapor deposition (CVD) method using a hydrocarbon gas, or by carbonizing a material to be used as a carbon source.

Specifically, the carbon layer may be formed by introducing the preliminary silicon-containing negative electrode active material into a reaction furnace, and then subjecting a hydrocarbon gas to chemical vapor deposition (CVD) at 600° C. to 1,200° C. The hydrocarbon gas may be at least one hydrocarbon gas selected from the group consisting of methane, ethane, propane and acetylene, and may be heat-treated at 900° C. to 1,000° C.

<Negative Electrode>

The negative electrode according to an exemplary embodiment of the present invention may include a negative electrode active material, and here, the negative electrode active material may include the above-described silicon-containing negative electrode active material.

In an exemplary embodiment of the present invention, the negative electrode active material may further include a carbon-containing negative electrode active material. The carbon-containing negative electrode active material may be at least one selected from natural graphite, artificial graphite, and the like.

In an exemplary embodiment of the present invention, a weight ratio of the silicon-containing negative electrode active material and the carbon-containing negative electrode active material in the negative electrode active material may be 10:90 to 90:10, specifically 10:90 to 50:50.

Specifically, the negative electrode may include a negative electrode current collector and a negative electrode active material layer on the negative electrode current collector. The negative electrode active material layer may include the negative electrode active material. Furthermore, the negative electrode active material layer may further include a binder and/or a conductive material.

The negative electrode current collector is sufficient as long as the negative electrode current collector has conductivity without causing a chemical change to the battery, and is not particularly limited. For example, as the current collector, it is possible to use copper, stainless steel, aluminum, nickel, titanium, fired carbon, or a material in which the surface of aluminum or stainless steel is surface-treated with carbon, nickel, titanium, silver, and the like. Specifically, a transition metal, such as copper or nickel which adsorbs carbon well, may be used as a current collector. Although the current collector may have a thickness of 6 μm to 20 μm, the thickness of the current collector is not limited thereto.

The binder may include at least one selected from the group consisting of a polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, polyacrylic acid, an ethylene-propylene-diene monomer (EPDM), a sulfonated EPDM, styrene-butadiene rubber (SBR), fluorine rubber, polyacrylic acid and a material in which the hydrogen thereof is substituted with Li, Na, Ca, or the like, and may also include various copolymers thereof.

The conductive material is not particularly limited as long as the conductive material has conductivity without causing a chemical change to the battery, and for example, it is possible to use graphite such as natural graphite or artificial graphite; carbon black such as acetylene black, Ketjen black, channel black, furnace black, lamp black, and thermal black; a conductive fiber such as carbon fiber or metal fiber; a conductive tube such as a carbon nanotube; a carbon fluoride powder; a metal powder such as an aluminum powder, and a nickel powder; a conductive whisker such as zinc oxide and potassium titanate; a conductive metal oxide such as titanium oxide; a conductive material such as polyphenylene derivatives, and the like.

In an exemplary embodiment of the present invention, the negative electrode may be prepared through preparing a negative electrode slurry including a negative electrode active material, a binder, a conductive material, and a solvent; forming a negative electrode active material layer by applying the negative electrode slurry to at least one surface of a current collector and drying and roll pressing the current collector; and drying the current collector in which the negative electrode active material layer is formed.

<Secondary Battery>

The secondary battery according to an exemplary embodiment of the present invention may include the above-described negative electrode according to an exemplary embodiment. Specifically, the secondary battery may include a negative electrode, a positive electrode, a separator interposed between the positive electrode and the negative electrode, and an electrolyte, and the negative electrode is the same as the above-described negative electrode. Since the negative electrode has been described in detail, a specific description thereof will be omitted.

The positive electrode may include a positive electrode current collector and a positive electrode active material layer on at least one side of the positive electrode current collector and including the positive electrode active material.

In the positive electrode, the positive electrode current collector is not particularly limited as long as the positive electrode current collector has conductivity without causing a chemical change to the battery, and for example, it is possible to use stainless steel, aluminum, nickel, titanium, fired carbon, or a material in which the surface of aluminum or stainless steel is surface-treated with carbon, nickel, titanium, silver, and the like. Further, the positive electrode current collector may typically have a thickness of 3 μm to 500 μm, and the adhesion of the positive electrode active material may also be enhanced by forming fine convex and concave irregularities on the surface of the current collector. For example, the positive electrode current collector may be used in various forms such as a film, a sheet, a foil, a net, a porous body, a foam, and a non-woven fabric body.

The positive electrode active material may be a typically used positive electrode active material. Specifically, the positive electrode active material includes: a layered compound such as lithium cobalt oxide (LiCoO₂) and lithium nickel oxide (LiNiO₂) or a compound substituted with one or more transition metals; a lithium iron oxide such as LiFe₃O₄; a lithium manganese oxide such as chemical formula Li_{1+c1}Mn_{2-c1}O₄; (0≤c1≤0.33), LiMnO₃, LiMn₂O₃, and LiMnO₂; a lithium copper oxide (Li₂CuO₂); a vanadium oxide such as LiV₃O₈, V₂O₅, and Cu₂V₂O₇; a Ni site type lithium nickel oxide expressed as chemical formula LiNi_{1-c2}M_{c2}O₂ (here, M is at least one selected from the group consisting of Co, Mn, Al, Cu, Fe, Mg, B and Ga, and c2 satisfies 0.01≤c2≤0.3); a lithium manganese composite oxide expressed as chemical formula LiMn_{2-c3}M_{c3}O₂ (here, M is at least any one selected from the group consisting of Co, Ni, Fe, Cr, Zn and Ta, and c3 satisfies 0.01≤c3≤0.1) or Li₂Mn₃MO₈ (here, M is at least any one selected from the group consisting of Fe, Co, Ni, Cu and Zn); LiMn₂O₄ in which Li of the chemical formula is partially substituted with an alkaline earth metal ion, and the like, but is not limited thereto. The positive electrode may be Li-metal.

The positive electrode active material layer may include a positive electrode conductive material and a positive electrode binder together with the above-described positive electrode active material.

In this case, the positive electrode conductive material is used to impart conductivity to the electrode, and can be used without particular limitation as long as the positive electrode conductive material has electron conductivity without causing a chemical change in a battery to be constituted. Specific examples thereof include graphite such as natural graphite or artificial graphite; a carbon-containing material such as carbon black, acetylene black, Ketjen black, channel black, furnace black, lamp black, thermal black, and carbon fiber; metal powder or metal fiber such as copper, nickel, aluminum, and silver; a conductive whisker such as zinc oxide and potassium titanate; a conductive metal oxide such as titanium oxide; or a conductive polymer such as a polyphenylene derivative, and any one thereof or a mixture of two or more thereof may be used.

In addition, the positive electrode binder serves to improve the bonding between positive electrode active material particles and the adhesion between the positive electrode active material and the positive electrode current collector. Specific examples thereof may include polyvinylidene fluoride (PVDF), a polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene monomer (EPDM), a sulfonated EPDM, styrene-butadiene rubber (SBR), fluorine rubber, or various copolymers thereof, and any one thereof or a mixture of two or more thereof may be used.

The separator separates the negative electrode and the positive electrode and provides a passage for movement of lithium ions, and can be used without particular limitation as long as the separator is typically used as a separator in a secondary battery, and in particular, a separator having an excellent ability to retain moisture of an electrolyte as well as low resistance to ion movement in the electrolyte is preferable. Specifically, it is possible to use a porous polymer film, for example, a porous polymer film formed of a polyolefin-based polymer such as an ethylene homopolymer, a propylene homopolymer, an ethylene/butene copolymer, an ethylene/hexene copolymer, and an ethylene/methacrylate copolymer, or a laminated structure of two or more layers thereof. In addition, a typical porous non-woven fabric, for example, a non-woven fabric made of a glass fiber having a high melting point, a polyethylene terephthalate fiber, and the like may also be used. Furthermore, a coated separator including a ceramic component or a polymeric material may be used to secure heat resistance or mechanical strength and may be selectively used as a single-layered or multi-layered structure.

Examples of the electrolyte include an organic liquid electrolyte, an inorganic liquid electrolyte, a solid polymer electrolyte, a gel-type polymer electrolyte, a solid inorganic electrolyte, a molten-type inorganic electrolyte, and the like, which can be used in the preparation of a lithium secondary battery, but are not limited thereto.

Specifically, the electrolyte may include a non-aqueous organic solvent and a metal salt.

As the non-aqueous organic solvent, it is possible to use, for example, an aprotic organic solvent, such as N-methyl-2-pyrrolidinone, propylene carbonate, ethylene carbonate, butylene carbonate, dimethyl carbonate, diethyl carbonate, γ-butyrolactone, 1,2-dimethoxy ethane, tetrahydrofuran, 2-methyl tetrahydrofuran, dimethyl sulfoxide, 1,3-dioxolane, formamide, dimethylformamide, dioxolane, acetonitrile, nitromethane, methyl formate, methyl acetate, phosphate triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate.

In particular, among the carbonate-based organic solvents, cyclic carbonates ethylene carbonate and propylene carbonate may be preferably used because the cyclic carbonates have high permittivity as organic solvents of a high viscosity and thus dissociate a lithium salt well, and such a cyclic carbonate may be more preferably used since the cyclic carbonate may be mixed with a linear carbonate of a low viscosity and low permittivity such as dimethyl carbonate and diethyl carbonate in an appropriate ratio and used to prepare an electrolyte having a high electric conductivity.

As the metal salt, a lithium salt may be used, the lithium salt is a material which is easily dissolved in the non-aqueous electrolyte, and for example, as an anion of the lithium salt, it is possible to use one or more selected from the group consisting of F⁻, Cl⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻ and (CF₃CF₂SO₂)₂N⁻.

In the electrolyte, for the purpose of improving the service life characteristics of a battery, suppressing the decrease in battery capacity, and improving the discharge capacity of the battery, one or more additives, such as, for example, a halo-alkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride may be further included in addition to the above electrolyte constituent components.

According to still another exemplary embodiment of the present invention, provided are a battery module including the secondary battery as a unit cell, and a battery pack including the same. The battery module and the battery pack include the secondary battery which has high capacity, high rate properties, and cycle properties, and thus, may be used as a power source of a medium-and-large sized device selected from the group consisting of an electric car, a hybrid electric vehicle, a plug-in hybrid electric vehicle, and a power storage system.

Hereinafter, preferred embodiments will be suggested to facilitate understanding of the present invention, but the embodiments are only provided to illustrate the present invention, and it is apparent to those skilled in the art that various alterations and modifications are possible within the scope and technical spirit of the present invention, and it is natural that such alterations and modifications also fall within the accompanying claims.

### EXAMPLES AND COMPARATIVE EXAMPLES

### Example 1-1

After 94 g of a powder in which Si and SiO₂ were mixed at a molar ratio of 1:1 and 6 g of Mg were mixed in a reaction furnace, the resulting mixture was heated under vacuum at a sublimation temperature of 1,400° C. Thereafter, a mixed gas of the vaporized Si, SiO₂, and Mg was reacted in a cooling zone in a vacuum state having a cooling temperature of 800° C. and condensed into a solid phase. Thereafter, a preliminary silicon-containing negative electrode active material was prepared by performing a heat treatment at a temperature of 800° C. (temperature of an additional heat treatment) in an inert atmosphere. Thereafter, after 15 sus ball media were introduced into the preliminary silicon-containing negative electrode active material using a ball mill, the preliminary silicon-containing negative electrode active material was prepared so as to have a size of D₅₀=6 μm by pulverizing the preliminary silicon-containing negative electrode active material for 3 hours. Thereafter, the preliminary silicon-containing negative electrode active material was positioned in a hot zone of a CVD apparatus while maintaining an inert atmosphere by flowing Ar gas, and the methane was blown into the hot zone at 900° C. using Ar as a carrier gas and reacted at 10⁻¹ torr for 20 minutes to prepare a silicon-containing negative electrode active material having a carbon layer formed on the surface.

### Example 1-2

A silicon-containing negative electrode active material was prepared in the same manner as in Example 1, except that 10 sus ball media were added thereto.

### Example 2-1

In the method of Example 1-1, Mg was not used, 94 g of SiO particles were synthesized, and then 6 g of a Li metal powder was added thereto, and a heat treatment was performed at a temperature of 800° C. in an inert atmosphere to prepare a preliminary silicon-containing negative electrode active material. Thereafter, after 15 sus ball media were introduced into the preliminary silicon-containing negative electrode active material using a ball mill, the preliminary silicon-containing negative electrode active material was prepared so as to have a size of D₅₀-6 μm by pulverizing the preliminary silicon-containing negative electrode active material for 3 hours. Thereafter, the preliminary silicon-containing negative electrode active material was positioned in a hot zone of a CVD apparatus while maintaining an inert atmosphere by flowing Ar gas, and the methane was blown into the hot zone at 900° C. using Ar as a carrier gas and reacted at 10⁻¹ torr for 20 minutes to prepare a silicon-containing negative electrode active material having a carbon layer formed on the surface.

### Example 2-2

A silicon-containing negative electrode active material was prepared in the same manner as in Example 3, except that 10 sus ball media were added thereto.

### Comparative Example 1-1

A silicon-containing negative electrode active material was prepared in the same manner as in Example 1, except that the pulverization time was modified to 8 hours.

### Comparative Example 1-2

A silicon-containing negative electrode active material was prepared in the same manner as in Example 1, except that the pulverization time was modified to 1 hour.

### Comparative Example 1-3

A silicon-containing negative electrode active material was prepared in the same manner as in Example 1-1, except that the pulverization time was modified to 5 hours.

### Comparative Example 1-4

A silicon-containing negative electrode active material was prepared in the same manner as in Example 1-1, except that 10 sus ball media were added thereto and the pulverization time was modified to 5 hours.

### Comparative Example 1-5

A silicon-containing negative electrode active material was prepared in the same manner as in Example 1-1, except that 30 sus ball media were added thereto and the pulverization time was modified to 8 hours.

### Comparative Example 1-6

A silicon-containing negative electrode active material was prepared in the same manner as in Example 1-1, except that 30 sus ball media were added thereto and the pulverization time was modified to 1 hour.

### Comparative Example 1-7

A silicon-containing negative electrode active material was prepared in the same manner as in Example 1-1, except that 30 sus ball media were added thereto.

### Comparative Example 2-1

A silicon-containing negative electrode active material was prepared in the same manner as in Example 2-1, except that the pulverization time was modified to 8 hours.

### Comparative Example 2-2

A silicon-containing negative electrode active material was prepared in the same manner as in Example 2-1, except that the pulverization time was modified to 1 hour.

### Comparative Example 2-3

A silicon-containing negative electrode active material was prepared in the same manner as in Example 2-1, except that the pulverization time was modified to 5 hours.

### Comparative Example 2-4

A silicon-containing negative electrode active material was prepared in the same manner as in Example 2-1, except that 10 sus ball media were added thereto and the pulverization time was modified to 5 hours.

### Comparative Example 2-5

A silicon-containing negative electrode active material was prepared in the same manner as in Example 2-1, except that 30 sus ball media were added thereto and the pulverization time was modified to 8 hours.

### Comparative Example 2-6

A silicon-containing negative electrode active material was prepared in the same manner as in Example 2-1, except that 30 sus ball media were added thereto and the pulverization time was modified to 1 hour.

### Comparative Example 2-7

A silicon-containing negative electrode active material was prepared in the same manner as in Example 2-1, except that 30 sus ball media were added thereto. The silicon-containing negative electrode active materials prepared in the Examples and the Comparative Examples are shown in the following Table 1.

TABLE 1

| | | | | | | | Parts by weight | |
|---|---|---|---|---|---|---|---|---|
| | | | | | | Specific | of metal | |
| | | | | | | surface area | atom based on core of | |
| | | | | | | (m²/g) of | silicon-containing | |
| | | | | | | silicon- | negative electrode | |
| | Particle size analysis of | | | | | containing | active material | |
| | silicon-containing negative | | | | | negative | Mg | Li |
| | electrode active material | | | | | electrode | content | content |
| | | D₅ | D₅₀ | Dₘₐₓ | Dₘᵢₙ | active | (parts by | (parts by |
| | D₅/D₅₀ | (μm) | (μm) | (μm) | (μm) | material | weight) | weight) |
| Example 1-1 | 0.5 | 3 | 6 | 19 | 2 | 3.5 | 6 | — |
| Example 1-2 | 0.6 | 3.6 | 6 | 17 | 2.5 | 2.5 | 6 | — |
| Example 2-1 | 0.5 | 3 | 6 | 19 | 2 | 3.5 | — | 6 |
| Example 2-2 | 0.6 | 3.6 | 6 | 17 | 2.5 | 2.5 | — | 6 |
| Comparative | 0.5 | 1.5 | 3 | 20 | 1 | 5.0 | 6 | — |
| Example 1-1 | | | | | | | | |
| Comparative | 0.5 | 6 | 12 | 40 | 5 | 2.0 | 6 | — |
| Example 1-2 | | | | | | | | |
| Comparative | 0.5 | 2.5 | 5 | 17 | 1.5 | 4.0 | 6 | — |
| Example 1-3 | | | | | | | | |
| Comparative | 0.6 | 2.52 | 4.2 | 15 | 1.5 | 4.0 | 6 | — |
| Example 1-4 | | | | | | | | |
| Comparative | 0.3 | 0.9 | 3 | 20 | 0.5 | 6.0 | 6 | — |
| Example 1-5 | | | | | | | | |
| Comparative | 0.3 | 3.6 | 12 | 40 | 2.5 | 2.5 | 6 | — |
| Example 1-6 | | | | | | | | |
| Comparative | 0.3 | 1.8 | 6 | 20 | 0.5 | 4.0 | 6 | — |
| Example 1-7 | | | | | | | | |
| Comparative | 0.5 | 1.5 | 3 | 20 | 1 | 5.0 | — | 6 |
| Example 2-1 | | | | | | | | |
| Comparative | 0.5 | 6 | 12 | 40 | 5 | 2.0 | — | 6 |
| Example 2-2 | | | | | | | | |
| Comparative | 0.5 | 2.5 | 5 | 17 | 1.5 | 4.0 | — | 6 |
| Example 2-3 | | | | | | | | |
| Comparative | 0.6 | 2.52 | 4.2 | 15 | 1.5 | 4.0 | — | 6 |
| Example 2-4 | | | | | | | | |
| Comparative | 0.3 | 0.9 | 3 | 20 | 0.5 | 6.0 | — | 6 |
| Example 2-5 | | | | | | | | |
| Comparative | 0.3 | 3.6 | 12 | 40 | 2.5 | 2.5 | — | 6 |
| Example 2-6 | | | | | | | | |
| Comparative | 0.3 | 1.8 | 6 | 20 | 0.5 | 4.0 | — | 6 |
| Example 2-7 | | | | | | | | |

The particle size analysis of the silicon-containing negative electrode active material may be confirmed using water and Triton-X100 dispersant under conditions of a refractive index of 1.97 using a Microtrac apparatus (manufacturer: Microtrac model name: S3500).

The specific surface area was measured by degassing gas at 130° C. for 2 hours using a BET measuring apparatus (BEL-SORP-MAX, Nippon Bell), and performing N₂ adsorption/desorption at 77 K.

The content of the metal atom was confirmed by an ICP analysis using an inductively coupled plasma atomic emission spectrometer (ICP-OES AVIO 500 of Perkin-Elmer 7300).

### Experimental Example: Evaluation of Discharge Capacity, Initial Efficiency, and Service Life (Capacity Retention Rate) Characteristics

Negative electrodes and batteries were prepared using the negative electrode active materials in the Examples and the Comparative Examples, respectively.

A mixture was prepared by mixing the negative electrode active material, a conductive material carbon black, and a binder polyacrylic acid (PAA) at a weight ratio of 80:10:10. Thereafter, 7.8 g of distilled water was added to 5 g of the mixture, and then the resulting mixture was stirred to prepare a negative electrode slurry. The negative electrode slurry was applied to a copper (Cu) metal thin film which is a negative electrode current collector having a thickness of 20 μm and dried. In this case, the temperature of the circulating air was 60° C. Subsequently, a negative electrode was prepared by roll pressing the negative electrode current collector and drying the negative electrode current collector in a vacuum oven at 130° C. for 12 hours.

A lithium (Li) metal thin film obtained by cutting the prepared negative electrode into a circle of 1.7671 cm² was used as a positive electrode. A porous polyethylene separator was interposed between the positive electrode and the negative electrode, vinylene carbonate was dissolved in 0.5 part by weight in a mixed solution of ethyl methyl carbonate (EMC) and ethylene carbonate (EC) at a mixed volume ratio of 7:3, and an electrolytic solution in which LiPF₆ having a concentration of 1 M was dissolved was injected thereinto to prepare a lithium coin half-cell.

The discharge capacity, initial efficiency, and capacity retention rate were evaluated by charging and discharging the prepared battery, and are shown in the following Table 2.

For the 1st and 2nd cycles, the battery was charged and discharged at 0.1 C, and from the 3rd cycle, the battery was charged and discharged at 0.5 C. The 300th cycle was completed in a charged state (with lithium contained in the negative electrode).

Charging conditions: CC (constant current)/CV (constant voltage) (5 mV/0.005 C current cut-off)

Discharging conditions: CC (constant current) conditions 1.5 V

The discharge capacity (mAh/g) and initial efficiency (%) were derived from the results during one-time charge/discharge. Specifically, the initial efficiency (%) was derived by the following calculation.

Initial efficiency (%)=(discharge capacity after 1 time discharge/1 time charge capacity)×100

The charge retention rate was each derived by the following calculation.

Capacity retention rate (%)=(300 times discharge capacity/1 time discharge capacity)×100

TABLE 2

| | Discharge | Initial | Capacity |
|---|---|---|---|
| | capacity | efficiency | retention rate |
| Battery | (mAh/g) | (%) | (%) |
| Example 1-1 | 1430 | 80 | 50 |
| Example 1-2 | 1450 | 80 | 52 |
| Example 2-1 | 1350 | 85 | 50 |
| Example 2-2 | 1360 | 85 | 52 |
| Comparative | 1420 | 79 | 35 |
| Example 1-1 | | | |
| Comparative | 1380 | 78 | 25 |
| Example 1-2 | | | |
| Comparative | 1420 | 78 | 25 |
| Example 1-3 | | | |
| Comparative | 1420 | 78 | 25 |
| Example 1-4 | | | |
| Comparative | 1390 | 78 | 25 |
| Example 1-5 | | | |
| Comparative | 1370 | 78 | 15 |
| Example 1-6 | | | |
| Comparative | 1420 | 79 | 45 |
| Example 1-7 | | | |
| Comparative | 1320 | 84 | 35 |
| Example 2-1 | | | |
| Comparative | 1300 | 80 | 25 |
| Example 2-2 | | | |
| Comparative | 1320 | 83 | 25 |
| Example 2-3 | | | |
| Comparative | 1320 | 83 | 25 |
| Example 2-4 | | | |
| Comparative | 1320 | 83 | 25 |
| Example 2-5 | | | |
| Comparative | 1300 | 80 | 15 |
| Example 2-6 | | | |
| Comparative | 1330 | 84 | 42 |
| Example 2-7 | | | |

The silicon-containing negative electrode active material according to the present invention includes a metal atom, is that wherein D₅/D₅₀ is 0.5 or more, D₅ is 3 pm or more, and D₅₀ is 4 μm or more and 11 μm or less, and has an effect that the capacity/efficiency is completely implemented and service life characteristics are stable because a side reaction with an electrolytic solution is suppressed and charging and discharging are facilitated by having an appropriate particle size distribution of D₅₀, D₅₀ and D₅/D₅₀.

In Table 2, it can be confirmed that Examples 1-1 and 1-2 are a negative electrode active material including Mg, and are excellent in all of the discharge capacity, initial efficiency and capacity retention rate compared to Comparative Examples 1-1 and 1-7 which do not satisfy the D₅/D₅₀ value, or do not satisfy the D₅ value and D₅₀ value. Further, it can be confirmed that Examples 2-1 and 2-2 are a negative electrode active material including Li, and are excellent in all of the discharge capacity, initial efficiency and capacity retention rate compared to Comparative Examples 2-1 to 2-7.

In contrast, Comparative Examples 1 and 5 satisfy the D₅/D₅₀, D₅, and D₅₀ of the present invention,

Comparative Examples 1-1 and 1-4 satisfy D₅/D₅₀ of the present invention, but do not satisfy D₅ or D₅₀, and it could be confirmed that the capacities, efficiencies and service lives were reduced compared to the Examples.

Specifically, even though D₅/D₅₀ is 0.5 or more, when D₅ is less than 3 μm or D₅₀ is less than 4 μm, the overall particle size is so small that the specific surface area of the material becomes large and oxidation occurs frequently. Therefore, it could be confirmed that the capacity, efficiency, and service life were lower than in the Examples because side reactions with an electrolytic solution frequently occurred during charging/discharging.

Further, even though D₅/D₅₀ is 0.5 or more, when D₅₀ exceeds 11 μm, the overall particle size was so large that it could be confirmed that the capacities, efficiencies and service lives were reduced compared to the Examples because the battery was not readily charged and discharged.

Also, when D₅/D₅₀ is less than 0.5, the volume occupied by the negative electrode active material, which has a size much smaller than D₅₀, in the negative electrode is increased, so that it could be confirmed that the capacity, efficiency and service life were reduced compared to the Examples because side reactions with an electrolytic solution were increased.

Therefore, the negative electrode active material of the present invention may satisfy a D₅/D₅₀ of 0.5 or more, a D₅ of 3 μm or more, and a D₅₀ value of 4 μm or more and 11 μm or less to minimize the oxidation of particles and reduce side reactions with the electrolytic solution, thereby readily improving the capacity, efficiency and/or service life of the battery.

What is claimed is:

1. A silicon-containing negative electrode active material, comprising:
a core and a carbon layer on the core,
wherein the core comprises SiOₓ, wherein 0<x<2 and at least one metal atom,
the at least one metal atom comprises at least one selected from the group consisting of Mg, Li, Al, and Ca,
wherein the silicon-containing negative electrode active material has a D₅/D₅₀ of 0.5 or more, and
the silicon-containing negative electrode active material has a D₅ of 3 μm or more, and a D₅₀ of 4 μm or more and 11 μm or less.

2. The silicon-containing negative electrode active material of claim 1, wherein the D₅/D₅₀ is 0.6 or more.

3. The silicon-containing negative electrode active material of claim 1, wherein the silicon-containing negative electrode active material has a D₅/D₅₀ of 0.5 or more and 1 or less.

4. The silicon-containing negative electrode active material of claim 1, wherein the D₅₀ is 4.2 μm or more and 10 μm or less.

5. The silicon-containing negative electrode active material of claim 1, wherein the D₅ is 3 μm or more and 5.5 μm or less.

6. The silicon-containing negative electrode active material of claim 1, wherein the silicon-containing negative electrode active material has a Dₘₐₓ of 35 μm or less.

7. The silicon-containing negative electrode active material of claim 1, wherein the at least one metal atom is comprised in an amount of 0.1 part by weight or more and 40 parts by weight or less based on a total 100 parts by weight of the silicon-containing negative electrode active material.

8. The silicon-containing negative electrode active material of claim 1, wherein the at least one metal atom comprises Mg or Li.

9. The silicon-containing negative electrode active material of claim 1, wherein the carbon layer is comprised in an amount of 0.1 part by weight or more and 50 parts by weight or less based on a total 100 parts by weight of the silicon-containing negative electrode active material.

10. The silicon-containing negative electrode active material of claim 1, wherein the silicon-containing negative electrode active material has a BET specific surface area is more than 2 m²/g and less than 10 m²/g.

11. A negative electrode comprising:
a negative electrode active material, wherein the negative electrode active material comprises the silicon-containing negative electrode active material of claim 1.

12. The negative electrode of claim 11, wherein the negative electrode active material further comprises a carbon-containing negative electrode active material.

13. The negative electrode of claim 11, further comprising
a negative electrode current collector; and
a negative electrode active material layer on at least one surface of the current collector,
wherein the negative electrode active material layer comprises the negative electrode active material.

14. A secondary battery comprising the negative electrode according to claim 11.
